(19) United States
(12) Patent Application Publication
(10) Pub. No.: US 2008/0010529 A1
(43) Pub. Date: Jan. 10, 2008

(54) Shock prevention structure for motor

(75) Inventors: Alex Hong, Kaohsiung City (TW); Sin Fu Ni, Kaohsiung City (TW); Kuo-Hsiang Chen, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/492,784

(22) Filed: Jul. 26, 2006

(30) Foreign Application Priority Data
Jun. 7, 2006 (TW) 95120151

(51) Int. Cl. G06F 11/00

(52) U.S. Cl. 714/31

(57) ABSTRACT

The present invention relates to a motor shock prevention structure, which is a shock prevention structure disposed between a metal tube and a fixing hole of the bottom plate in a motor such that the metal tube and the bottom plate are not directly contacted. Moreover, the shock prevention structure includes integrating at least a shock prevention element and a gasket. As the shock prevention element is made of a flexible material being shock-absorbent and damping, the vibration amplitude during motor rotation won't be transmitted to the bottom plate and the electronic system due to the damping function of the shock prevention element, and the resonant effect and noise out of vibration occurring in an electronic system is avoided.

### FIELD OF THE INVENTION

The present invention relates to a shock prevention structure for motor, and more particularly to a practical structure that isolates and alleviates the vibration arising from motor operation transmitted to an electronic system, so as to protect the electronic system and secure normal efficacy and operation life span thereof.

### BACKGROUND OF THE INVENTION

A spindle motor is employed inside an electronic system to serve as the main driving power source as shown in FIG. 1. The spindle motor structure mainly includes a bottom plate 10, a metal tube 20, a stator set 30 and a rotor 40.

The bottom plate 10 is a foundation structure where the spindle motor is integrated with the electronic system. A fixing hole 11 is disposed on the surface of the bottom plate for insertion of the metal tube 20, and the metal tube 20 is fixed with the bottom plate 10 by means of a riveting method of a riveting part 21 (the mentioned riveting method is not further disclosed as it pertains to a conventional technique and has no direct correlation to the characteristics of the present invention).

The stator set 30 is composed of a plurality of silicon steel sheets disposed by surrounding a coil and is fixed on the outer circumference of the metal tube 20.

The metal tube 20 is formed with a single-sided tube body having an opening at its top end. A bearing 22 is placed in the metal tube 20, and a rotational shaft 41 is encircled by the bearing 22 in the bore of the bearing 22, such that the rotational shaft 41 is supported and rotated in the bore. The top end of the rotational shaft 41 is bundled with the rotor 40, enabling the stator set 30 to be symmetrically enveloped in the rotor 40.

However, the aforementioned conventional spindle motor structure is prone to the resonant effect and noise of the electronic system.

As the metal tube 20 and the bottom plate 10 are directly fixed by the riveting part 21, the vibration resulting from rotation of the rotor 40 and the vibration generated by the attrition between the rotational shaft 41 and the bearing 22 will be transmitted through the bottom plate 10 to affect the efficacy of the entire electronic system while the spindle motor rotates. Consequently, the electronic system will result in severe resonant effect and noise out of vibration. In particular, as far as an electronic system requiring high-precision optical read and write is concerned, the resonant effect easily leads to a misjudged optical read/write value. Moreover, the electronic system consistently located at a vibrating environment may further accelerate the fatigue and the aging of the contact point of the internal component and shorten the life cycle of the electronic system.

As such, to completely solve the resonant effect issue of the mentioned electronic system and maintain the normal efficacy and the life cycle of the electronic system, developing a motor shock prevention structure is indispensable.

### SUMMARY OF THE INVENTION

In view of the forgoing concern, the present invention thus provides a motor shock prevention structure, wherein the motor contains a bottom plate, a fixing hole disposed on the bottom plate, a metal tube inserted in the fixing hole, a stator set disposed around the outer circumferential surface of the metal tube, a bearing inserted in the metal tube, and a rotational shaft supported by the bearing and rotated therein.

The shock prevention structure has a shock prevention element disposed between the metal tube and the fixing hole of the bottom plate, such that the metal tube and the bottom plate won't be directly contacted, and is made of a flexible material having shock-absorbent and damping effect. During the assembling process, a gasket is placed underneath the shock prevention element, and a riveting method is applied to integrally fix and integrate the metal tube, the shock prevention element and the bottom plate.

Given the shock prevention structure, the vibration amplitude arising from rotation of motor rotor and the vibration amplitude generated from the attrition between the rotational shaft and the bearing won't be directly transmitted to the bottom plate by virtue of the isolating and damping effect of the shock prevention element. Accordingly, the efficacy of the electronic system won't be affected, and the resonant effect and the noise out of vibration to the electronic system can be further avoided to maintain the normal efficacy and operation life span of the electronic system.

### BRIEF DESCRIPTION OF THE DRAWINGS

FIG. 1 is a cross-sectional view showing a conventional shock prevention structure;

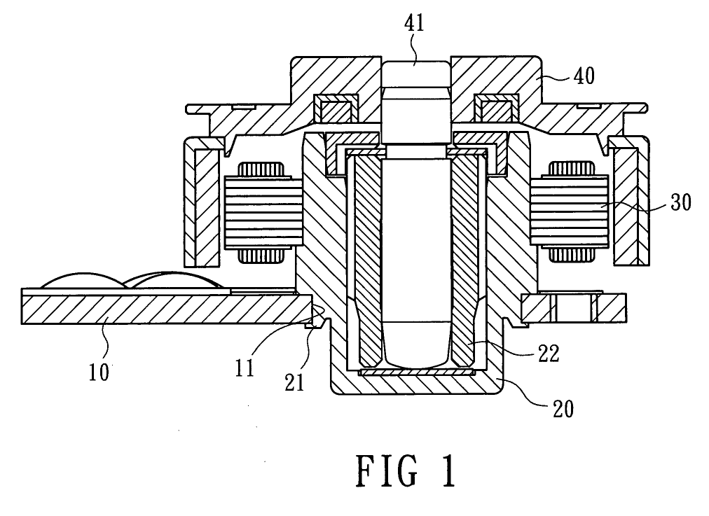

FIG. 2A is a cross-sectional view showing a first preferred embodiment (without gasket) of the present invention;

FIG. 2B is a cross-sectional view showing a first preferred embodiment (with gasket) of the present invention;

FIG. 3 is a cross-sectional view showing a third preferred embodiment of the present invention; and

FIG. 4 is a cross-sectional view showing a fourth preferred embodiment of the present invention.

### DETAILED DESCRIPTION OF THE PREFERRED EMBODIMENT

The present invention relates to a motor shock prevention structure, which has a shock prevention element with shock-absorbent and damping effect disposed between the metal tube of motor and the bottom plate. Therefore, the vibration amplitude generated by the motor rotor and the vibration amplitude generated by the attrition between the rotational shaft and the bearing won't be directly transmitted to the bottom plate, thereby isolating the vibration amplitude from the electronic system.

Listed below are several preferred embodiments of the present invention applicable to the spindle motor.

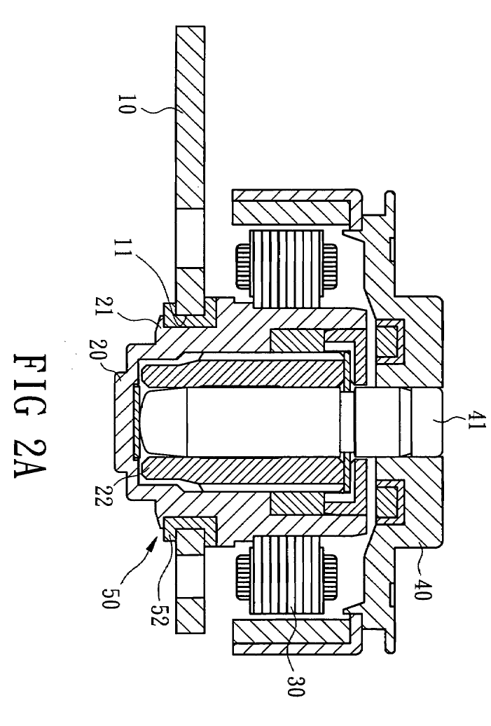

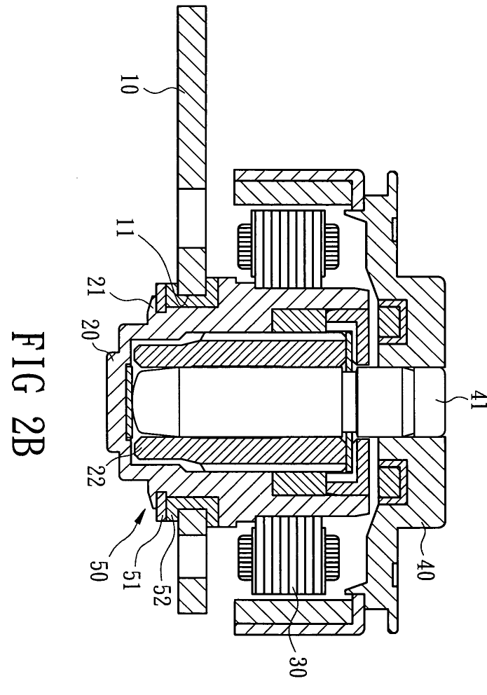

As shown in FIG. 2A and 2B relating to a first preferred embodiment of the present invention actually applied to the spindle motor, the spindle motor includes a bottom plate 10, a metal tube 20, a stator set 30, and a rotor 40.

A fixing hole 11 is disposed on a bottom plate 10 for insertion of the metal tube 20. The stator set 30 is fixed on the outer circumference of the metal tube 20. A bearing 22 is disposed in the metal tube 20. A rotational shaft 41 is encircled by the bearing in the bore of the bearing 22 such that the rotational shaft 41 can be supported and rotated in the bore. The top end of the rotational shaft 41 is fixed and bundled with the rotor 40, enabling the stator set 30 to be symmetrically enveloped in the rotor 40.

At least a shock prevention element 52 is disposed between the metal tube 20 and the fixing hole 11 of the bottom plate 10 as shown in FIG. 2A.

The shock prevention element 52 shall be made of a flexible material with shock-absorbent and damping function, such as rubber, polyurethane, and the like. The shock prevention element 52 in the preferred embodiment has a [symbol] -shaped cross section and covers the inner periphery and the top and bottom surfaces to prevent the metal tube 20 from being directly contacted with the bottom plate 10.

A gasket 51 can be also disposed beneath the shock prevention element 52 as shown in FIG. 2B. The metal tube 20, the shock prevention element 52, the gasket 51 and the bottom plate 10 are integrally fixed and bundled by means of a riveting method of a riveting part 21.

When the spindle motor rotates, the vibration amplitude generated by rotation of the rotor and the vibration amplitude generated by the attrition between the rotational shaft 41 and the bearing 22 can all be isolated and damped by means of the shock prevention element 52. The vibration amplitude won't be transmitted to the bottom plate, as a result, the efficacy of the electronic system won't be affected, the resonant effect and the noise out of vibration occurring in the electronic system won't be caused, and the normal efficacy and operation life span of the electronic system can be secured.

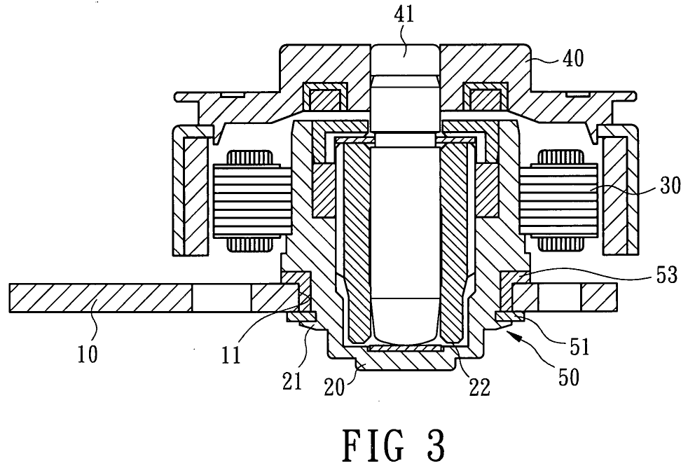

FIG. 3 illustrates a second preferred embodiment of the present invention, in which the shock prevention structure 50 also contains a shock prevention element 53 in combination with a gasket 51.

The shock prevention element 53 shall be made of a flexible material having both shock-absorbent and damping functions, such as rubber, polyurethane, and the like. The shock prevention element 53 of the preferred embodiment has an L-shaped cross section and covers the inner circumference and the top surface of the fixing hole 11, such that the metal tube 20 has no direct contact with the bottom plate 10.

While bundling, the gasket 51 is disposed underneath the shock prevention element 53, and the metal tube 20, the shock prevention element 52 and the bottom plate 10 are integrally fixed and bundled by means of a riveting method of the riveting part 21.

Likewise, the vibration amplitude generated by rotation of the rotor 40 and the vibration amplitude generated by attrition between the rotational shaft 41 and the bearing 22 can be isolated and damped, and the severe resonant effect and noise out of vibration occurring in the electronic system can be prevented.

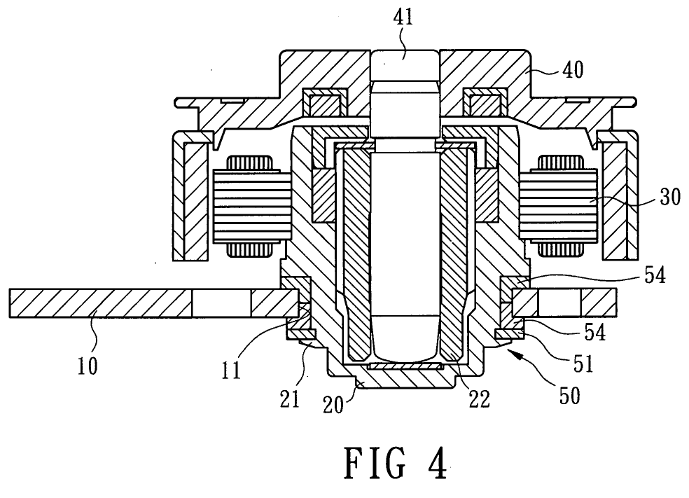

In addition, as shown in FIG. 4, two shock prevention elements 54 having an L-shaped cross section are reversely disposed to cover the top edge and the bottom edge of the inner circumference of the fixing hole 11. Both shock prevention elements 54 can be assembled to form a cross section resembling a [symbol] shape. Thus, the vibration amplitude generated by rotation of the rotor 40 and the vibration amplitude generated by attrition between the rotational shaft 41 and the bearing 22 can be isolated and damped, the severe resonant effect and the noise out of vibration occurring in the electronic system can be prevented, and the normal efficacy and operation life span of the electronic system can be secured.

In sum, the motor shock prevention structure in the present invention can isolate and damp the vibration amplitude generated by rotating rotor to avoid the transmission of the vibration amplitude and the impact on the efficacy of electronic system, thereby enabling to maintain normal efficacy and operation life span of electronic system. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motor shock prevention structure, comprising:
a bottom plate with a fixing hole disposed thereon;
a metal tube inserted in said fixing hole;
a stator set disposed on said metal tube;
a bearing disposed in said metal tube;
a rotational shaft supported by said bearing and rotated therein;
a rotor fixed with a top end of said rotational shaft; and
a shock prevention element disposed between said metal tube and said fixing hole of said bottom plate such that said metal tube and said bottom plate has no direct contact and is made of a flexible material being shock-absorbent and damping.

2. The motor shock prevention structure of claim 1 further comprises a gasket disposed underneath said shock prevention element and is integrally fixed with said metal tube and the said bottom plate by a riveting method.

3. The motor shock prevention structure of claim 1, wherein said shock prevention element is made of rubber.

4. The motor shock prevention structure of claim 1, wherein said shock prevention element is made of polyurethane.

5. The motor shock prevention structure of claim 1, wherein said shock prevention element has a [symbol] -shaped cross section and covers an inner circumference, and a top and a bottom surfaces of the fixing hole.

6. The motor shock prevention structure of claim 1, wherein said shock prevention element has an L-shaped cross section and covers said inner circumference and said top surface of said fixing hole.

7. The motor shock prevention structure of claim 1, wherein said shock prevention element has an L-shaped cross section and covers said inner circumference and said bottom surface of said fixing hole.
